(19) United States
(12) Patent Application Publication
(10) Pub. No.: US 2016/0305376 A1
(43) Pub. Date: Oct. 20, 2016

(54) FILTER ELEMENT, IN PARTICULAR FOR GAS FILTRATION

(71) Applicant: MANN+HUMMEL GMBH, Ludwigsburg (DE)

(72) Inventors: Robert Hasenfratz, Waiblingen (DE); Torsten Fritzsching, Vaihingen/Enz (DE)

(21) Appl. No.: 15/130,186

(22) Filed: Apr. 15, 2016

(30) Foreign Application Priority Data
Apr. 15, 2015 (DE) 10 2015 004 641.1

(51) Int. Cl. F02M 35/024; F02M 35/02; B01D 46/00

(52) U.S. Cl. CPC F02M 35/02416; B01D 46/0005; B01D 46/002; F02M 35/0215

(57) ABSTRACT

A filter element comprises one first and at least one second filter media body disposed at a common carrier body. At least one filter media body is formed in a curved manner.

### TECHNICAL FIELD

The present invention relates to a filter element, in particular for gas filtration.

### BACKGROUND

A filter element is known from DE 10 2011 083 657 A1, which is used for a fresh air system of a vehicle and which comprises two filter media bodies held at a common carrier body. The filter media bodies each are configured as cube-shaped pleated filters.

The filter media bodies limit an intermediate clean chamber from which the cleaned air through-flowing the filter media bodies from the outside to the inside is axially discharged.

A filter element having a compressible filter media body for filtering gaseous fluids is known from EP 2 135 662 A1. The filter media body is annularly formed and is through-flown radially from the outside to the inside so that the enclosed interior space forms the clean side. The filter media body is inserted into a filter housing which is closeable by a cover.

### SUMMARY

The object of the present invention is to create a compactly designed filter element having a high filtration performance.

The filter element according to the present invention is preferably used for filtering gas, for example, for filtering the combustion air for an internal combustion engine or for cleaning fresh air supplied to cabins, for example, vehicle interiors. The filter element can, however, also be used for filtering liquids.

The filter element comprises at least two separately formed filter media bodies at which the filtration is carried out. The filter media bodies are disposed at a common carrier body and are situated opposite each other so that a flow chamber situated between the filter media bodies is formed, into which the fluid through-flowing the filter media body is received. Preferably, the flow direction is from the outside to the inside so that the flow chamber located between the filter media bodies forms the clean chamber, into which the cleaned fluid is received and out of which the fluid can be discharged. A flow in the counter direction is, however, also conceivable so that the intermediate flow chamber forms the crude chamber into which the uncleaned fluid is conducted, whereupon the fluid through-flows the filter media body from the inside to the outside. If the filter media bodies are through-flown from the outside to the inside, the outside forms the crude side and the inside of the filter media bodies forms the clean side. If the flow occurs from the inside to the outside, the inside of the filter media bodies forms the crude side and the outside forms the clean side.

At least one filter media body is formed in a curved manner so that the crude or inflow side and/or the clean or outflow side of this filter media body is also curved. The curvature extends at least over one section of the filter media body and enables an improved adaptation to correspondingly formed installation spaces into which the filter element or the filter device comprising the filter element can be inserted. Accordingly, for example, when using a curved filter media body, better use can be made of curved installation spaces, as a result of which the filtration performance is increased.

A further advantage of the curvedly implemented filter media body is owing to the targeted impact onto the flow of the fluid through this filter media body. Curved filter media bodies enable to adjust for accelerated or delayed flows. In the present embodiment, the filter media bodies are formed either convexly or concavely outwards. For example, the flow is increased if the inflow side is curved convexly outwards and is correspondingly delayed if the inflow side is curved concavely outwards.

Furthermore, owing to the curvature, differently sized areas at the inflow side and outflow side can be advantageously used for filtering the fluid. If the inflow side has a greater surface area, the inflow having the crude fluid is distributed to the respectively enlarged crude side of the filter media body, which is more slowly clogged by dirt particles.

In the embodiment of the filter element according to the present invention, at least one filter media body is at least in sections formed in a curved manner. It can be advantageous that the filter media body is completely curved. Furthermore, embodyments in which the filter media body has at least one curved and at least one straight section are also possible. In each case, the filter media bodies each are preferably integrally manufactured from filter material. Each filter media body can be implemented as a pleated filter and can, for example, be made of a pleated paper or nonwoven material. Embodiments of the filter media bodies made out of a compact filter material, however, may also be considered.

Furthermore, embodiments are possible in which all filter media bodies are at least partially, optionally completely, formed in a curved manner, as well as embodiments in which only one filter media body is partially or completely formed in a curved manner and the second filter media body is, either at its inflow side and/or at its outflow side, formed in a straight manner, for example, formed in the shape of a cube.

Furthermore, embodiments are possible in which the curved sections of the filter media bodies have a constant curvature, as well as embodiments in which the curvature in the filter media body changes. The change can be carried out continuously or discontinuously.

According to an advantageous embodiment, the center point of the curvature of the filter media body is at a distance from the longitudinal axis of the filter element. In an alternative embodiment, the center point of the curvature of the filter media body coincides with the longitudinal axis of the filter element.

The inflow side and the outflow side of the filter media body can be situated parallel or concentrically to each other. In an alternative embodiment, the inflow side and the outflow side of the filter media body are not parallel or are not concentric.

According to a further expedient embodiment, the at least two filter media bodies are situated without touching each other and are at a distance from each other in the filter element. Located between the filter media bodies is the flow chamber, which is, owing to the distance between the filter media bodies, open at least at two sides, and the open sides can be closed by housing parts. End faces or end surfaces of the filter media bodies facing each other are situated at a distance from each other so that at least one gap between the filter media bodies is provided. According to a further advantageous embodiment, a guide element disposed at the carrier body and, in particular integrally formed with the carrier body, can be disposed in this gap between the adjacent filter media bodies. The guide element is used to guide and hold the filter element in a filter housing by inserting said filter element into said filter housing. The guide element is, for example, configured as a guide rail, which extends approximately or completely over the height or length of the filter media body. The guide element can, however, also be configured as a guide fin preferably extending approximately or completely over the width of the gap between the adjacent filter media bodies.

In an alternative embodiment, the filter media bodies touch or nearly touch in at least one location.

According to a further expedient embodiment, the carrier body receiving and supporting the filter media bodies forms a support lattice or support frame, through the recesses of which the fluid can through-flow. This embodiment is suitable, for example, for two or a plurality of filter media bodies enclosing a partially round cross section and a cylindrically shaped support frame forming a center tube, the end surfaces of the filter media bodies touching or nearly touching so that the filter material of the filter media bodies continuously or at least approximately encloses the cylindrical support frame in the circumferential direction without a gap. Based on the partial circular shape, each filter media body has a curvature. The filter element can, however, also have a flat, approximately elliptical or oval cross section, the filter media bodies being situated at the longitudinal sides or engaging over the narrow sides. In a variation, two end plates are integrally formed with the cylindrical support lattice, at least one end plate, preferably a closed end plate, comprising at least one step in the axial direction. In doing so, the filter element is divided into at least two sections of different lengths. Accordingly, the filter media bodies disposed between the end plates have different lengths.

According to a further advantageous embodiment, the carrier body forms a filter element housing into which also the intermediate flow chamber is received. In this instance, the filter element housing flow-tightly closes off the flow chamber to the outside on those sides at which no filter media body is located. A flow aperture for supplying or discharging the fluid into or out of the flow chamber can be introduced into one of the ceilings or side walls of the filter element housing, which are limiting the flow chamber. Optionally, a plurality of such flow apertures are introduced into the filter element housing.

Additionally or alternatively, it is also possible to introduce a flow aperture directly into a filter media body, via which the fluid is conducted into or out of the flow chamber. For example, when the filter media body is in-flown from the outside to the inside, the intermediate flow chamber is used as a clean chamber from which the cleaned fluid can be discharged via one or a plurality of flow apertures in the filter media bodies. It suffices to introduce a flow aperture into only one filter media body. Embodiments in which either a plurality of flow apertures are introduced into one filter medium and/or in which one or a plurality of flow apertures are introduced into each filter media body are also possible.

The filter media bodies can be identically configured or differ in one or a plurality of parameters, for example, they can have different axial lengths, different radial extensions, for example, different pleat depths and/or extend over angular segments different in size. As a result, an optimal adaptation to the provided installation space is possible.

### BRIEF DESCRIPTION OF THE DRAWINGS

Further advantages and expedient embodiments may be concluded from the further claims, the description of the figures and the drawings.

FIG. 1 shows a perspective view of a filter element having two filter media bodies curved convexly outwards which are situated opposite each other at a common carrier body;

FIG. 2 shows the filter element according to FIG. 1 in an exploded view;

FIG. 3 shows a filter element in a variant embodiment having two filter media bodies shaped concavely outwards at a common carrier body;

FIG. 4 shows a filter element in a further variant embodiment in which the filter media body comprises a straight and a curved section;

FIG. 5 shows a further filter element in which a flow aperture in a cover plate is introduced into the carrier body forming a filter element housing;

FIG. 6 shows a further filter element having a flow aperture in a side wall of the filter element housing;

FIG. 7 shows a filter element according to FIG. 6, a filter media body being cube-shaped and a further filter media body being curved convexly outwards;

FIG. 8 shows a further filter element having a flow nozzle introduced into the filter element housing, which extends in the direction of one filter media body;

FIG. 9 shows a further filter element having two concavely curved filter media bodies situated opposite each other which are implemented in a stepped manner;

FIG. 10 shows a further filter element having two filter media bodies strongly curved convexly outwards at a carrier body configured as a support frame, which has an approximately elliptical cross section;

FIG. 11 shows the filter element according to FIG. 10 in an exploded view;

FIG. 12 shows a further filter element having two filter media bodies lightly curved convexly outwards at a support frame having an approximately elliptical cross section, comprising guide rails extending over the height, which are disposed at the support frame;

FIG. 13 shows a filter element similar to the one in FIG. 12, having fin-shaped guide elements in side areas of the support frame;

FIG. 14 shows a perspective view of a filter element in a further variant embodyment having two filter media bodies comprising a semi-circular cross section at a hollow-cylindrical support frame;

FIG. 15 shows the filter element from FIG. 14 in an exploded view;

FIG. 16 shows the two filter element bodies from FIG. 14 or 15 in a section transverse to the longitudinal axis;

FIG. 17 shows a corresponding sectional view of two filter media bodies having partially circular-shaped cross sections, the filter media bodies extending over angular segments different in size;

FIG. 18 shows, in a further variant embodiment, a sectional view of two filter media bodies having partially circular shaped cross sections, the two filter media bodies being different in size in the radial direction.

In the figures, same components are provided with the same reference characters.

### DETAILED DESCRIPTION

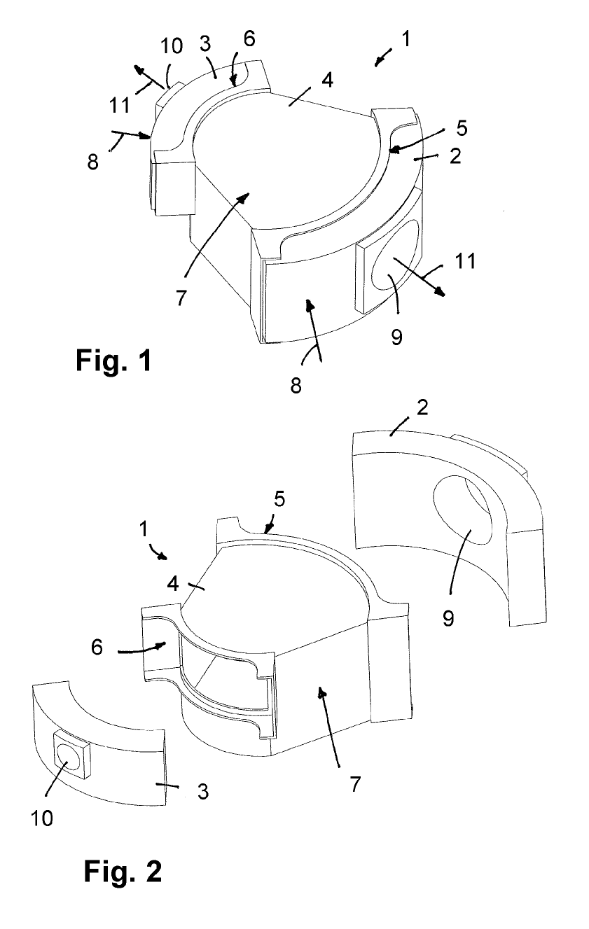

The first exemplary embodiment according to FIGS. 1 and 2 shows a filter element 1 for filtering gas, having two filter media bodies 2 and 3, both of which are received and held at a common carrier body 4. Oppositely situated receiving pockets 4 and 5 for receiving respectively one filter media body 2 or 3 are located at the carrier body preferably implemented as a plastic injection molding component. Accordingly, filter media bodies 2, 3 are disposed opposite each other at carrier body 4 and enclose between each other a flow chamber 7 serving to receive the cleaned fluid.

Carrier body 4 is configured as a filter element housing, flow chamber 7 being located in a closed-off manner within the filter element housing between two filter media bodies 2 and 3 and being flow-tightly sealed to the outside via side walls and cover plates or bottom plates. The flow is guided according to arrows 8 from the outside to the inside through filter media bodies 2 and 3 so that the outside of filter media bodies 2 and 3 forms the crude side and the inside facing flow chamber 7 forms the clean side; accordingly, the flow chamber forms the clean chamber for receiving the cleaned fluid.

The outflow of the fluid out of flow chamber 7 occurs according to flow arrows 11 via flow apertures 9 and 10 introduced into filter media bodies 2 or 3. Flow apertures 9, 10 are centrally disposed in filter media bodies 2, 3; optionally, they can also be positioned off-center. One flow aperture 9, 10 for discharging the cleaned fluid from flow chamber 7 is located in each filter media body 2, 3; however, two or a plurality of flow apertures can also be optionally provided per filter media body 2, 3 for discharging the fluid. Furthermore, it is possible to introduce such a flow aperture into only one filter media body.

Filter media bodies 2, 3 are either made of a block-like filter material or are configured as pleated filters.

Each filter media body 2, 3 is curved convexly outwards, the curvature being constant and extending over the total length of each filter media body 2, 3. Filter media bodies 2, 3 are different in size; they differ with regard to both its height and also its length. The curvature between filter media bodies 2, 3 is at least approximately equal in size; however, optionally, if can also be different in size.

Each filter media body 2, 3 comprises an inherent rigidity which is large enough so that the curved shape is maintained also in the non-installed initial state of the filter media body. Also possible, however, is an embodiment in which the curved state is assumed and maintained only after insertion into the respective receiving pocket 5, 6 at carrier body 4. Receiving pockets 5, 6 are formed radially outwardly open and have in the circumferential direction or upwards and downwards limiting walls and also have a surrounding limiting edge to inside flow chamber 7, onto which each filter media body 2, 3 is fitted.

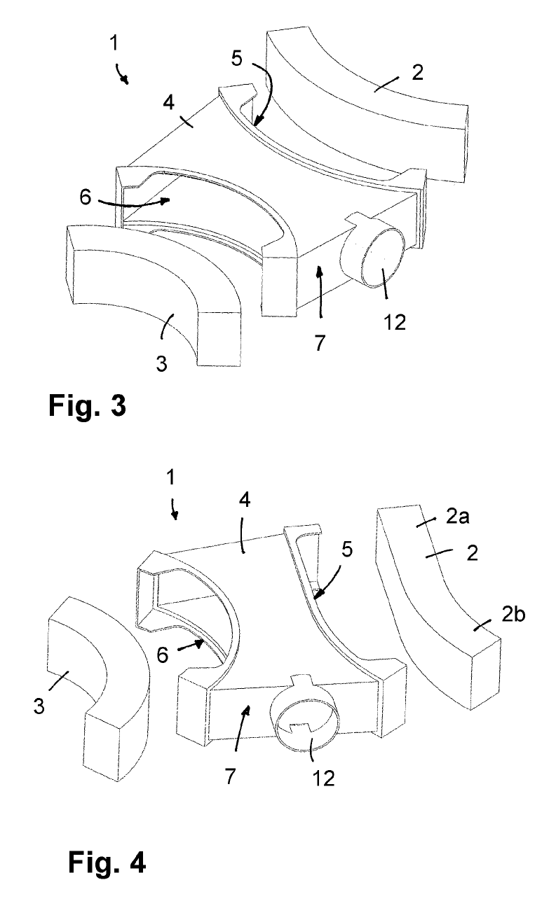

In the exemplary embodiment according to FIG. 3, filter element 1 also comprises a central carrier body 4 in the form of a filter element housing in which a flow chamber 7 is formed located between filter media bodies 2 and 3 disposed at the edges in receiving pockets 5 and 6. Filter media bodies 2 and 3 are provided with a constant curvature and are shaped concavely outwards. Filter media bodies 2, 3 can differ with regard to its size, embodiments having filter media bodies equal in size also being conceivable.

At carrier body 4, a flow aperture 12 is located in a flow nozzle which is integrally formed with carrier body 4 and via which the cleaned fluid received into flow chamber 7 is discharged. Flow aperture 12 at the flow nozzle is located at a side wall of carrier body 4, which delimits inside flow chamber 7 and extends between filter media bodies 2 and 3.

The exemplary embodiment according to FIG. 4 substantially corresponds with that of FIG. 3; also according to FIG. 4, two filter media bodies 2, 3 are curved concavely outwards, as a result of which the outflow side of the filter media bodies facing intermediate flow chamber 7 has a larger area than the outside outflow or crude side. First filter media body 2, however, does not have a constant curvature but is rather composed of two sections 2a and 2b of which first section 2a is implemented as a straight, cube-shaped block and only second section 2b connecting thereto has a curvature. Two sections 2a and 2b are at least approximately equal in size. In contrast, oppositely situated filter media body 3 has a constant curvature.

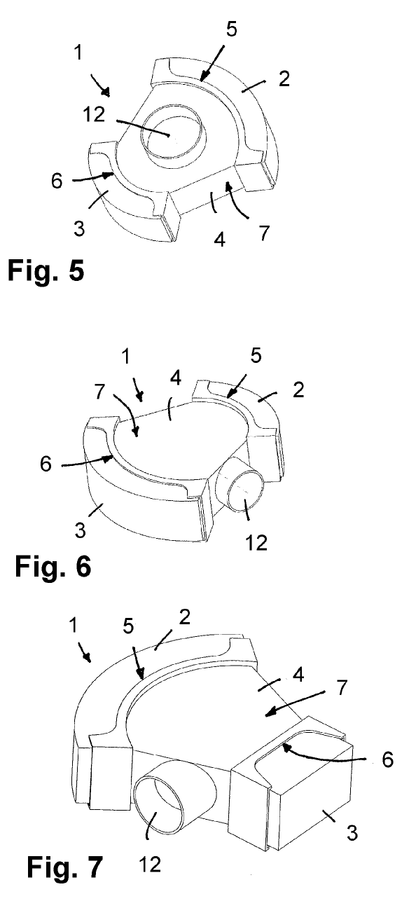

In the exemplary embodiment according to FIG. 5, two filter media bodies 2 and 3 are, as in the first exemplary embodiment according to FIGS. 1 and 2, curved convexly outwards and received into receiving pockets 5 and 6 of a carrier body 4 forming a filter element housing. Flow chamber 7 situated between filter media bodies 2 and 3 in carrier body 4 has a flow aperture 12 in a cover plate located in an assigned flow nozzle. The flow nozzle is situated centrally in the above cover plate of carrier body 4.

In FIG. 6, filter element 1 is carried out analogously to the exemplary embodiment according to FIG. 5; however, the cleaned fluid outflows from interior flow chamber 7 via flow aperture 12 into a nozzle which is introduced into a side wall in carrier body 4 extending between filter media bodies 2 and 3.

In the exemplary embodiment according to FIG. 7, first filter media body 2 is curved convexly outwards; in contrast, second filter media body 3 is formed as a cube without a curvature. Filter media bodies 2 and 3 have different volumes and inflow and outflow areas different in size.

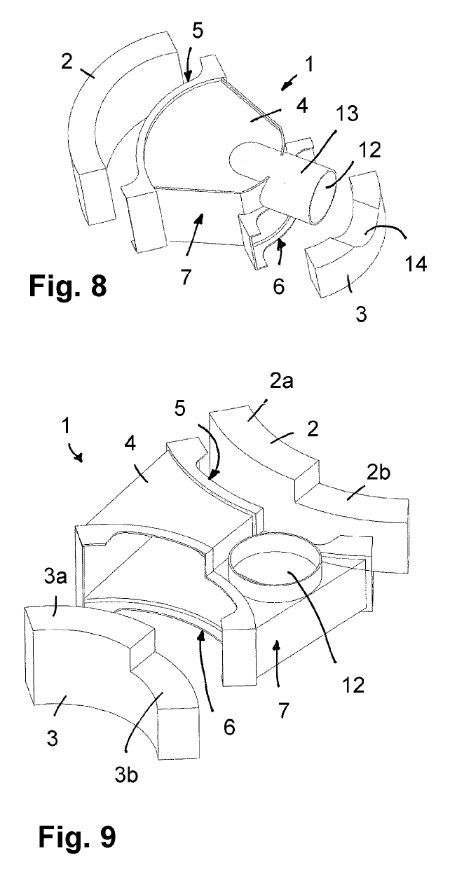

In the exemplary embodiment according to FIG. 8, both filter media bodies 2, 3 are, as for example in FIG. 6, curved convexly outwards and are situated in receiving pockets 5, 6 of carrier body 4 implemented as a filter element housing. The outflow of the cleaned fluid out of intermediate flow chamber 7 in carrier body 4 occurs via a flow aperture 7 at a nozzle 13 integrally formed with carrier body 4 and extending directly above filter media body 3. Partially circular recess 14, through which nozzle 13 is guided, is introduced into the top side of filter media body 3.

In the exemplary embodiment according to FIG. 9, both filter media bodies 2, 3 are, analogously to FIG. 3, curved concavely outwards. Both filter media bodies 2, 3 are implemented in a stepped manner and comprise sections 2a or 3a being greater in height and sections 2b, 3b being smaller in height.

The outflow from inside situated flow chamber 7 occurs via a flow aperture 12 which is introduced into the cover plate of carrier body 4. Just as are filter media bodies 2, 3, the cover plate is also implemented in a stepped manner. Flow aperture 12 is located in the lower section of carrier body 4.

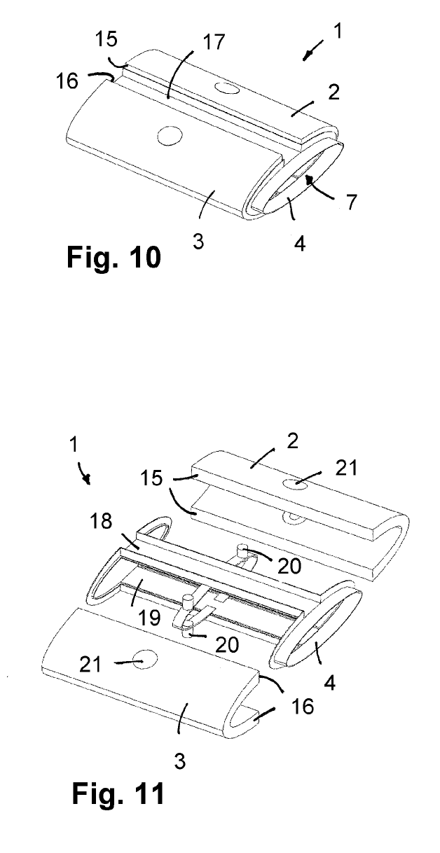

In the exemplary embodiment according to FIGS. 10 and 11, carrier body 4 of filter element 1 is configured as a support frame or support lattice having lattice bars and intermediate apertures, at which two filter media bodies 2 and 3 abut and which lends stability to the filter media bodies. Carrier body 4 is formed in a strongly oval manner. Two filter media bodies 3 configured mirror-symmetrically to each other engage around the narrow side of carrier body 4. Accordingly, filter media bodies 2 and 3 feature a strong curvature extending over an angular area larger than 90°. In the exemplary embodiment, the angle which is covered by each filter media body 2, 3, is on the order of above 120°.

Two filter media bodies 2, 3 do not touch each other but are rather spaced apart. Bellow-type ends (end surfaces) 15, 16 of the filter media bodies are spaced apart, as a result of which an intermediate gap 17 is formed on both sides of carrier body 4 between filter media bodies 2 and 3. In the area of gap 17, carrier body 4 is solidly formed by a wall section 18 or 19 to sealingly enclose inside flow chamber 7 in carrier body 4.

In order to achieve a fixed connection between filter media bodies 2, 3 and carrier body 4, spigots 20 are disposed at the carrier body, which project in the installed state into assigned recesses 21 in filter media bodies 2, 3.

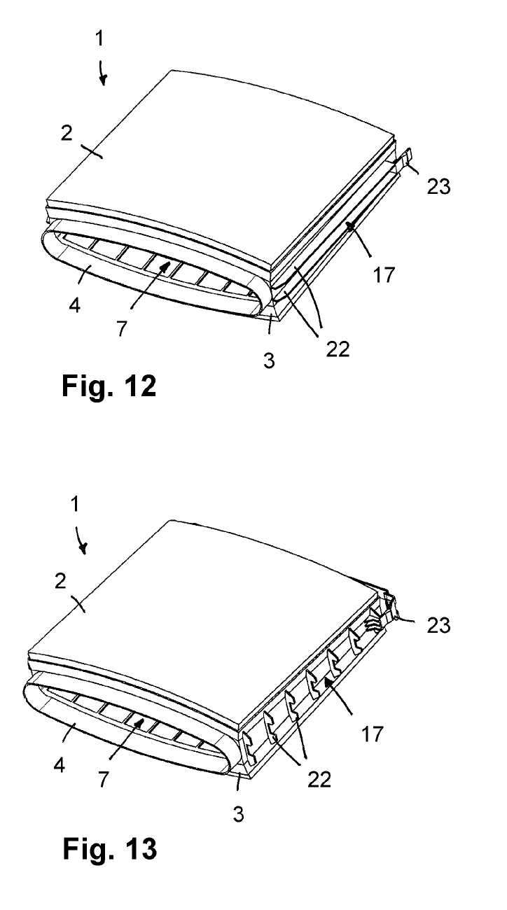

In the exemplary embodiment according to FIG. 12, filter element 1 is formed proportionately flat having a smaller ovality. Carrier body 4 is implemented as a support frame or a support lattice supporting two curved filter media bodies 2, 3. Filter media bodies 2, 3 are located on the longitudinal outside of carrier body 4 and comprise a proportionately small, convex curvature facing outwards, which covers an angular area significantly smaller than 90°.

In the area of the narrow sides of carrier body 4, respectively one gap lies between filter media bodies 2, 3. Guide elements 22 are located in at least one gap, which are, in FIG. 12, formed as two parallel running rails extending over the height of filter element 1. On one side of filter element 1, an axially projecting snap-fit element 23 for locking by means of a receiving filter housing or a cover is situated as an axial extension of rail-shaped guide elements 22.

The exemplary embodiment according to FIG. 13 substantially corresponds with that of FIG. 12; however, it is different in that guide rails 22 disposed in lateral gap 17 are formed as U-shaped fins extending transversely to the longitudinal direction. A plurality of such parallel disposed guide elements 22 are disposed over the height.

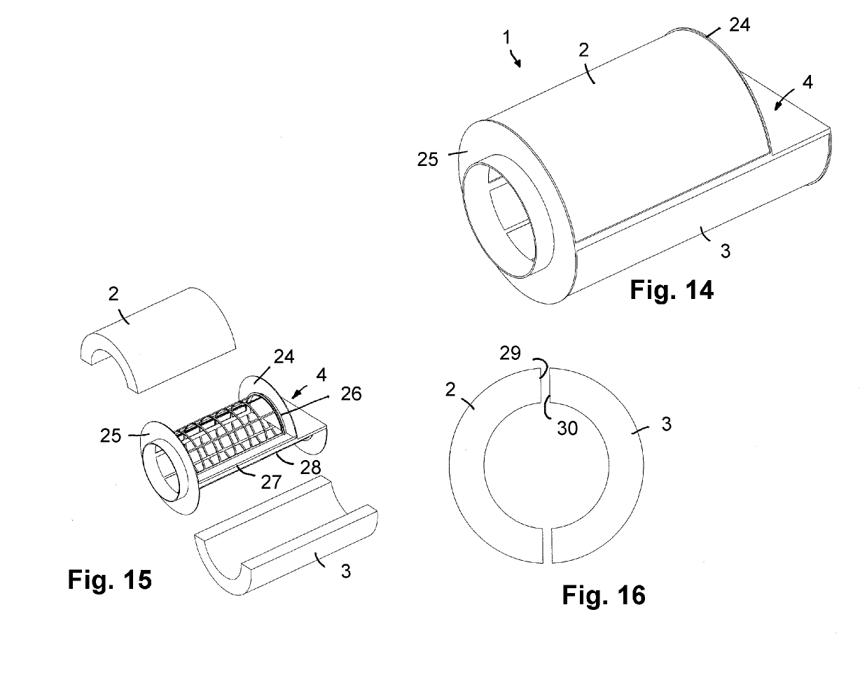

In FIGS. 14 through 16, a further exemplary embodiment is shown in which filter element 1 is formed hollow-cylindrically. Filter element 1 comprises two filter media bodies 2, 3, each of which comprises a semi-circular cross section and which extends over an angular segment of approximately 180°. Carrier body 4 is implemented as a hollow-cylindrical support frame and has a row of circumferential struts, between which recesses are formed, through which the fluid to be cleaned can through-flow. In the installed state, carrier body 4 is situated at the inside of filter media bodies 2, 3 simultaneously forming the outflow or clean side.

Two filter media bodies 2, 3 have axial lengths different in size. Filter media body 2 is implemented being shorter than filter media body 3, the difference being 20%.

Integrally formed with carrier body 4 are two end plates 24 and 25, which flow-tightly cover the end faces of filter media bodies 2 and 3. The end faces of filter media bodies 2 and 3 are adhesively bonded with end plates 24, 25. In order to prevent that adhesive flows radially inwards along end plates 24, 25, at the inside of end plates 24, 25, respectively surrounding, circular grooves 26 are introduced into the end plates, which serve to receive outflowing adhesive. Grooves 26 are located directly radially outside of the cage-like support frame.

Furthermore, an axial groove 27 extending in axial length is introduced into a section 28 at carrier body 4, which is formed in a straight, even manner and which extends radially outside of the support cage between two end plates 24 and 25. End surfaces 29, 30 of filter media bodies 2, 3 abut at opposite sides of section 28; introduced into each of these sides is an axial groove 27 which is used for receiving adhesive, by means of which end surfaces 29, 30 are flow-tightly adhesively bonded with section 28.

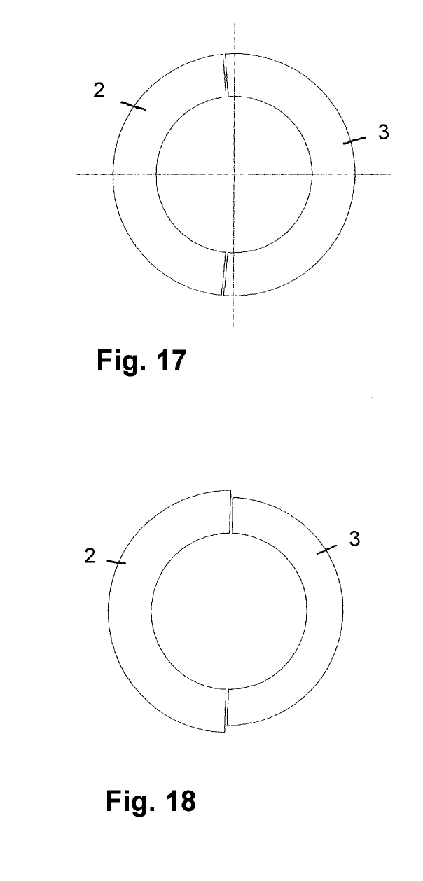

FIG. 17 shows a variant embodiment of two filter media bodies 2, 3, each having a semi-circular cross section and the same inner and outer radius. Two filter media bodies 2, 3 each extend over circular segments of different sizes, filter media body 2 extending over a circular segment slightly smaller than 180° and filter media body 3 extending over a circular segment slightly larger than 180°.

FIG. 18 shows a further variant embodiment in which two filter media bodies 2, 3 each extend over 180°. Filter media bodies 2, 3 have the same inner radius; however, they have outer radii different in size. Filter media body 2 is provided with a larger outer radius than filter media body 3 so that filter media body 3 has a smaller radial extension than filter media body 2. In contrast, in the exemplary embodiment according to FIGS. 14 through 17, two filter media bodies 2, 3 are provided with the same radial extension.

What is claimed is:

1. A filter element, comprising:
a first filter media body; and
at least one second, separately formed filter media body;
wherein the filter media bodies are through-flowable by a to-be-cleaned fluid;
wherein the filter media bodies are arranged on a common carrier body;
wherein the filter media bodies limit an intermediate flow chamber for the fluid;
wherein at least one of the filter bodies is formed at least in sections in a curved manner;
wherein the filter element has a longitudinal axis.

2. The filter element according to claim 1, wherein
all of the filter media bodies are formed at least in sections in a curved manner.

3. The filter element according to claim 1, wherein
at least one filter media body of the filter media bodies comprises one curved and one straight section.

4. The filter element according to one of claim 1, wherein
at least one of the filter bodies is formed exclusively in a curved manner.

5. The filter element according to claim 1, wherein
a curvature of the if the at least one filter media body curved in sections provided a curved filter media body having a curvature that extends over an angular span larger than 90 degrees.

6. The filter element according to claim 1, wherein
the curvature of the if the at least one filter media body curved in sections provided a curved filter media body having a curvature that extends over an angular span less than 45 degrees.

7. The filter element according to claim 1 wherein
a curvature of the if the at least one filter media body curved in sections has a center point of the curvature spaced away from the longitudinal axis of the filter element.

8. The filter element according to claim 1, wherein
at least two of the filter media bodies are spaced apart from each other without touching.

9. The filter element according to claim 1, wherein
two of the filter media bodies abut against each other, at least in one location.

10. The filter element according to claim 1, wherein
at least one filter media body of the filter media bodies is curved convexly outwardly.

11. The filter element according to claim 1, wherein
at least one filter media body of the filter media bodies is curved concavely outwards.

12. The filter element according to claim 1, wherein
the carrier body is configured as a support lattice.

13. The filter element according to claim 12, wherein
the support lattice is configured cylindrically; and
wherein the filter media bodies each have a partially circular cross section and engage around the support lattice.

14. The filter element according to claim 1, wherein
at least one filter media body of the filter media bodies includes at least one flow aperture supplying or discharging fluid.

15. A filter device, comprising:
a filter element, including:
a first filter media body; and
at least one second, separately formed filter media body;
wherein the filter media bodies are through-flowable by a to-be-cleaned fluid;
wherein the filter media bodies are arranged on a common carrier body;
wherein the filter media bodies limit an intermediate flow chamber for the fluid;
wherein at least one of the filter bodies is formed at least in sections in a curved manner; and
wherein the filter element has a longitudinal axis; and
a filter housing in which the filter element is received.
